(19) United States
(12) Patent Application Publication
(10) Pub. No.: US 2009/0210295 A1
(43) Pub. Date: Aug. 20, 2009

(54) System and Method for Enabling Carbon Credit Rewards for Select Activities

(76) Inventors: Yorgen Edholm, Palo Alto, CA (US); Nikhil Jhingan, Singapore (SG); Paula Skokowski, Palo Alto, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 12/369,731

(22) Filed: Feb. 11, 2009

Related U.S. Application Data
(63) Continuation-in-part of application No. 12/135,082, filed on Jun. 6, 2008.
(60) Provisional application No. 61/027,818, filed on Feb. 11, 2008.

(51) Int. Cl. G06Q 99/00; G06Q 10/00; G06Q 50/00

(52) U.S. Cl. 705/11; 705/1

(57) ABSTRACT

A set of activities are identified that are part of a defined objective to reduce carbon emission. A baseline for the set of activities is determined. An actor's performance of any one of the set of activities is monitored in order to determine information about how the user performed the set of activities. A quantification (e.g. estimation) is made of the carbon conservation by the actor by comparing the information against parameters determined or identified from the baseline.

### RELATED APPLICATIONS

This application claims benefit of priority to Provisional U.S. Patent Application No. 61/027,818, filed Feb. 11, 2008; the aforementioned priority application is being hereby incorporated by reference in its entirety.

This application is a continuation-in-part of U.S. patent application Ser. No. 12/135,082, filed Jun. 6, 2008, entitled SYSTEM AND METHOD FOR PRESENTING INFORMATION ABOUT CONSERVATION ACTIVITIES OF AN ORGANIZATION; the aforementioned priority application is being hereby incorporated by reference in its entirety.

### BACKGROUND

Carbon Credits are quantitative instruments that help mitigate global warming. Carbon Credits help organizations and entitys lower their carbon footprint through the purchase of carbon offsets. Carbon Credits enable reduction of greenhouse gas emissions, at comparably lowest cost.

Current implementation of carbon credits may be illustrated by the following example. Assume that a power plant is inefficient in that it generates too much green house gasses, and that the owner of the power plant is required to decrease the “carbon footprint” per energy produced. The power plant owner has several options: the plant can be shut down, in favor of a more green house friendly counterpart (e.g. a nuclear reactor or wind turbine farm). The use of carbon credits enables a third option: the plant owner can keep his plant operation and purchase carbon credits to offset his plant's production of greenhouse gasses. For example, the plant proprietor may purchase the carbon offset credits of a couple of thousand trees that absorb as much greenhouse gasses as the power plant produces. If the total cost of the land, planting and managing the forest is less than the alternatives, planting a certain number of trees may produce the best solution.

Carbon Credits and Carbon Credit Exchanges are a convenient way for carbon sources to quickly determine the cost of purchasing or using carbon credits. In some situations, carbon credit exchanges may facilitate entities to make efficient carbon credit transactions without having to become experts in managing carbon sinks (such as forests or algae farms). In this way, it is anticipated that Carbon Credits and Carbon Credit Exchanges will enable reduction of overall greenhouse gas emissions in an efficient and cost effective manner.

Carbon Credits have been introduced for processes, and projects, that absorb greenhouse gasses and thereby create carbon sinks. These carbon sinks create offsets to the carbon sources thereby reducing the overall effects on global warming.

### BRIEF DESCRIPTION OF THE DRAWINGS

FIG. 1 illustrates a system for enabling the determination of carbon credits for a specific user activity, under an embodiment of the invention.

FIG. 2 illustrates a method for enabling the determination of carbon credits, under an embodiment of the invention.

### DETAILED DESCRIPTION

Still further, another embodiment provides a system for quantifying carbon usage or reduction. The system may include an activity monitor and a calculator. The activity monitor is configured to detect a designated activity or behavior in order to generate data that reflects information about the user performing the designated activity. The calculator coupled to communicate with the activity monitor to receive the data. In an embodiment, the calculator determines a quantity of carbon usage or reduction

Embodiments described herein provide a computer-implemented method for quantifying carbon usage or reduction. A method such as described may be implemented or otherwise performed using one or more devices, including at least one or more processors. In an embodiment, a set of activities are identified that are part of a defined objective to reduce carbon emission. A baseline for the set of activities is determined. An actor's performance of any one of the set of activities is monitored in order to determine information about how the user performed the set of activities. A quantification (e.g. estimation) is made of the carbon conservation by the actor by comparing the information against parameters determined or identified from the baseline.

With regard to any of the embodiments described herein, carbon reduction may be quantified as carbon credits and then ‘monetized’ or otherwise exchanged for value. Various forums may be used to enable such exchanges, including marketplaces or exchanges.

Embodiments described herein recognize that the use of Carbon Credits may be extended or expanded further from its current implementation to incentivize or reward individuals or other entities (e.g. corporations; “entities”) for performing specific activities in a manner that is deemed to reduce carbon footprints. In particular, embodiments described herein incentivize entities to stop, or at least reduce, activities that generate greenhouse gasses in the first place. Such use of incentives would reduce the carbon sources. In an embodiment, carbon credits are assigned to behavior or actions of entities that are directly tied to that entity's carbon reduction/emission.

Some embodiments assign carbon credits to specific activities and then calculates the carbon reduction/emission based on a specific action or inaction that the entity performed (or not performed). Specific examples include, for example, in the instance of transportation, tabulating carbon credits for entities based on the entities use of a hybrid or electrical car (“event activity approach”). Other embodiments assign carbon credits to behaviors that encompass a totality of actions or parameters for an objective or a behavioral goal (“objective totality approach”). Under the objective totality approach, the actions or behaviors may correspond to one or more parameters that quantify the entity's behavior in comparison to a baseline model, to reflect direct or real-world impact of the user's activities/behavior with regard to the objective (e.g. reduction of carbon for the entities' transport needs). Such totality approach thus would not reward carbon credits simply for a person driving a hybrid, if, for example, the person was using the hybrid to travel extensively, as the vehicle's benefits may be counterbalanced with the user driving the car extensively for leisure. Rather, the totality approach may consider real-world parameters that directly measure or relate to carbon emissions, such as how much fuel the person consumed. In order to correlate this to carbon emission reduction, the objective totality approach may utilize baseline models that account for various parameters or factors, such as transportation distances traveled by persons on typical basis, (e.g. what is the user's profession, how close does he live to work, how often does he telecommute). Such an approach may reward the actor who carpools in an SUV, as well as the actor who drives the hybrid.

The objective totality approach may further enable detection of parameters that counterbalance good behavior (i.e. are considered bad behavior), but would otherwise be undetected without considering the totality of the objective. For example, for an objective that seeks tor reduce carbon emission in relation to driving, an event activity approach may seek to identify (i) whether the user has a hybrid or other low emission fuel efficient car, (ii) instances of the user carpooling. With the objective totality approach, the parameters may consider the user's total fuel consumption, so as to account for when the user drives his car for leisure, takes public transportation, or carpools. As explained below, a more comprehensive baseline determination/model may be needed for the totality approach, in order to enable and motivate the actor to conserve fuel and reduce emissions. Nevertheless, the focus of the parameters would be to reflect a direct measurement of a real world result (e.g. total fuel consumption by a user and total distance driven), rather than on specific activities that are indirect measurements (does the person use a hybrid).

Still further, parameters may be identified that would reduce the chance that the actor's good deed (e.g. use insulation in his house) would be offset by an unknown bad deed (leave the window open when the heater is open). Under a real world approach, the parameter of interest would focus on the person's energy consumption at his house, and compare that determination to a baseline formulation. These parameters would be considered real-world parameters that directly impact the objective (e.g. reduce carbon emission when heating or cooling one's home).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

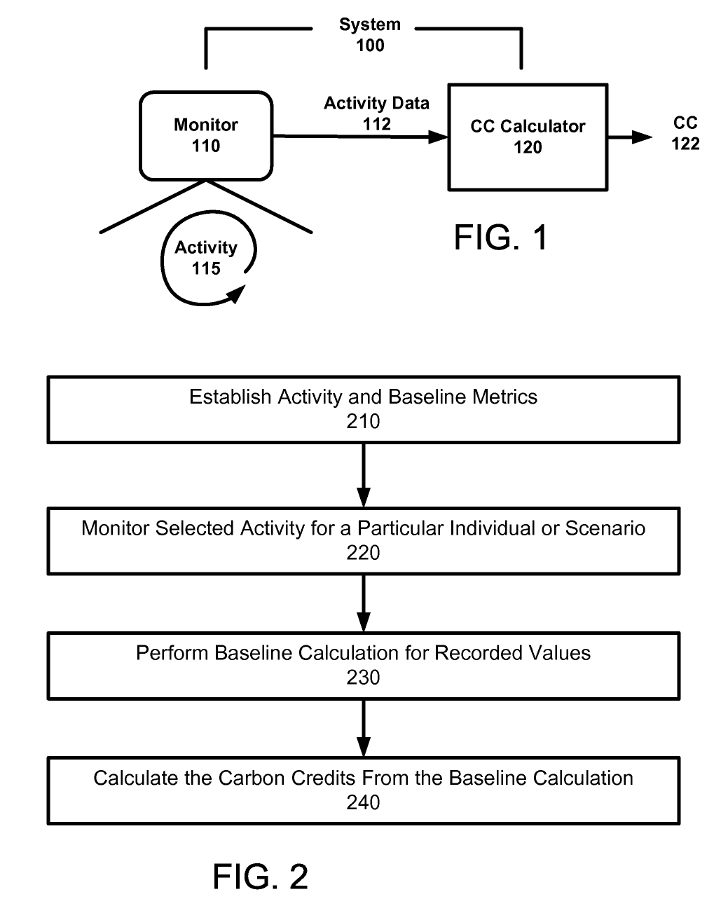

Any of the embodiments described with FIG. 1 may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, any embodiments described herein may be implemented through the use of instructions that are executable by one or more processors. These instructions may be carried on a computer-readable medium. Machines or modules shown in figures provided herein include examples of processing resources and computer-readable mediums on which instructions for implementing embodiments of the invention can be carried and/or executed. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

### Overview

According to an embodiment, a system is provided for determining carbon credits. The system may include one or more activity monitoring processes or devices (“activity monitor”) and a Carbon Credit calculator. The activity monitor may be configured to detect, determine or receive information about a user performing a specific activity. The activity may be pre-selected and qualified as one where its manner of performance is likely to reduce the so-called greenhouse gasses. The activity monitor is further configured to generate data that reflects the information about the user performing the specific activity. The Carbon Credit calculator is coupled to communicate with the activity monitor to receive the data. The Carbon Credit calculator determines a Carbon Credit amount based on the data received from the activity monitor. As described below, the carbon credit calculation may be calculated under the event activity approach, the objective totality approach (meaning more than one parameter or activity event is considered), or a hybrid approach.

In one embodiment, the Carbon Credit determination is quantified as a standard unit or credit that represents a designated amount of reduction in greenhouse gasses.

FIG. 1 illustrates a system for enabling the determination of Carbon Credits for a specific user activity, under an embodiment of the invention. System 100 includes a monitor 110 that is capable of interacting and/or recording a specific activity or class of activity that is performed by a user 111. Additionally, the system 100 may include a Carbon Credit calculator 120, which communicates to receive data 112 from the monitor 110.

An embodiment assumes an entity 111 may participate or perform a given activity 115 that is pre-determined for use with system 100. The activity 115 may be pre-selected for its use in determining carbon savings using different criteria. Examples of activities may include (i) a user telecommuting rather than commuting to work, (ii) a user electing to have online meetings rather than meetings in person, (iii) a user sending documents electronically rather than through traditional courier, (iv) driving or means by which the user conducts transport. In embodiments in which an objective totality approach is utilized, multiple kinds of events that fall under a general carbon reduction (or ‘greenness’) directive are tabulated. More over, on any application, embodiments described herein recognize that the activity 115 that is selected for system 100 should be qualified to reward Carbon Credits for appropriate ‘green’ behavior, rather than to facilitate entities who may game the system to procure credits. In particular, embodiments recognize that the use of carbon credits as currency or exchange may benefit from a baseline formation that is directly tied to the estimated carbon reduction (or so called ‘green savings’).

One challenge to the concept of rewarding specific behavior or activities with Carbon Credits is to use discipline and scientific honesty in determining what activities are to be rewarded. Otherwise abuse could water down the value of the carbon credits, and may even diminish the exchanges that trade them. For instance, if Carbon Credits were granted to entities for using online meeting places (e.g. Web-Ex demos) on the basis that such an “activity” is replacing a face-to-face meeting where some of the participants may have flown cross country, people could easily schedule online meetings for unnecessary purposes to falsely generate Carbon Credits. Thus, for example, a Web-Ex demo “activity” replaces a necessary meeting, that would have taken place even if the cost of the meeting involved thousands of dollars in travel costs and lost time, or if the meeting is a more opportunistic meeting, or maybe even just a glorified replacement for a phone call, makes using a web-ex demo a difficult candidate for receiving Carbon Credits.

Qualifications may be established to recognize or qualify the activity 115 (under any kind of approach). For example, the activity 115 may be selected on basis of criteria that inherently precludes abuse for Carbon Credit. As an alternative or addition, certain conditions may be required before a user's performance of an activity is qualified for use with system 100.

The monitor 110 may correspond to a component, or a system of interconnected components, that serve to monitor or record the activity 115 of users. In an embodiment, the monitor 110 corresponds to a web interface and/or a program that executes on a general purpose computer and/or other device to monitor the activity 115. The monitor 110 may receive input from the user that (i) identifies an activity that the user has selected to participate in for purpose of receiving the Carbon Credits, and (ii) information or input that reflects whether and/or the degree to which the user is achieving desirable metrics in performing the activity.

As an alternative or addition, the monitor 110 may be a component that programmatically and/or automatically records a particular activity. For example, the activity may correspond to the number of electronic file transfers a person transmits that contain documents or other material that more conventional behavior would ship through courier. In such a case, the monitor 110 may be a programmatic component that counts the number of file transfers the person performs.

As another example such as described in more detail below, the activity may correspond to “driving”. The monitor 110 may correspond to an onboard computer of a vehicle. In other examples, the monitor 110 may provide a component that interfaces with (i) the energy usage or system of a household or building (e.g. monitor use of heating or air conditioning), (ii) water usage (toilet flush counter, water meter interface), or (iii) other resource monitor. Numerous other examples are possible and contemplated with various embodiments.

According to an embodiment, monitor 110 communicates activity data 112 to the carbon credit calculator 120. The activity data 112 may reflect, for example, the number of online meetings a person has held, the number of files electronically transferred in lieu of courier, the metrics (speed, fuel consumption) of the user driving etc.

In one embodiment, the Carbon Credit calculator 120 is a programmatically implemented process (such as one that runs on a network computer or system) that calculates carbon credits 122 from information that includes the activity data 112 and baseline data for this activity. The Carbon Credit calculator 120 may select a formula, algorithm or other means by which Carbon Credits 122 can be determined for the user 111 performing the activity at a given time and/or for a particular duration. As described with an embodiment of FIG. 2, the determination may be based on a baseline. The Carbon Credit calculator 120 may be provided as part of or in connection with a service to enable exchange of carbon credits for other benefits (such as discounts of goods and services, or money).

As described further, the baseline determination may be one that is based on either the event activity approach or the totality objective approach. Either approach may include a model or function for determining the baseline that incorporates various parameters or input criteria, based on the specific actor that is being motivated. The event activity approach may use relatively simple parameters for comparison determination. The totality objective approach may model the baseline on multiple parameters, with emphasis on modeling the ‘real world situation’. Such real world modeling may derive a baseline equation or function that serves to identify the primary factors that affect the objective. For example, for an objective to reduce greenhouse reduction through reduction or elimination of couriers (which may be implemented for corporate entity), a primary parameter to consider is the elimination of packages that need to be couriered. But another parameter to consider is the mode of transport and the route taken for individual packages. The determination of these parameters better identifies the carbon impact of sending (or not sending packages). In comparison, the size and weight of individual packages has little impact and would not be a large part of the model.

FIG. 2 illustrates a computer-implemented method for enabling the determination of Carbon Credits, under an embodiment of the invention. A method such as described may be implemented using a system such as described with an embodiment of FIG. 1. Furthermore, a method such as described may be implemented in connection with a standard by which the value of Carbon Credits may be exchanged or understood. For example, a method such as described may enable calculation and determination of Carbon Credits for use in a marketplace or through exchange or credit with vendors, service providers, government entities etc.

In a step 210, an activity and its baseline metrics are established for an objective for carbon reduction. As an alternative, a set of activities and a respective baseline metric for the objective of the activity may be established. A given objective may be analyzed to determine specific activities that are to be monitored. Results from the entity participating the activities of the objective may be compared individually, or in combination, to a baseline to determine carbon emission reduction (and this carbon credit calculation). In either case, the baseline metrics may define parameters by which performance of the activity, or set of activities, in a particular manner is to be rewarded. For example, the baseline metrics may correspond to (i) a range of values that define the manner in which a given entity is to perform a particular activity; (ii) weights or calculations by which different activities for one objective are to counter-balance or offset one another.

As an example, an activity that may be selected for Carbon Credit savings may be that of vehicular transport, or “driving”. It is well known that automobiles emit significant amounts of greenhouse gasses (usually as a direct function of the measured fuel consumption). With vehicles, greenhouse consumption may be estimated on an entity basis, taking into account specific metric values such as speed and mileage. Thus, it is possible to quantify greenhouse emission savings by comparing certain measured metrics to hypothetical values (i.e. the baseline). Hence, in activities such as driving, high integrity carbon savings can be calculated, tracked and aggregated.

For the activity of driving, the metrics may refer to those that reflect fuel savings, such as the overall fuel consumption of an entity's vehicle, the speed the entity drives at a given instance, and the acceleration or de-acceleration that takes place when a user drives the vehicle. The metrics may be determined at specific instances and/or over a given duration of time. Numerous other metrics may also be established. The baseline for the metrics may refer to optimal speeds, values for acceleration or de-acceleration, and fuel consumption of the vehicle (whether absolute or relative to make and model of vehicle).

The base line data for a particular activity may be determined on factors that include the behavior of numerous entities, as aggregated and analyzed through statistical methods. For driving activity, the base line metrics may be determined through a calculation of the behavior of the average car, which may be dependent on the behaviors of entity cars that are aggregated using statistical analysis. For example, the “the average 4 door mid-priced sedan” may be calculated by establishing the base line performance for the top models representing for example, 80% of all cars in a specific market, and weighing the aggregated specific base lines according to the number of cars of each model. Independent calculations by various research groups may, for example, verify baseline values for identified metrics.

Still further, as mentioned above, objective totality approach may incorporate numerous parameters in order to determine real world impact of the observed or monitored activity or activities that impact the desired objective. To reduce emissions from cars, a simplistic or event activity approach may incorporate the type of car a person drives. However, under a more comprehensive real world approach (i.e. objective totality approach), the actual emission reduction associated with the driving activity of the actor may be determined in view of the modeled baseline. In such context, the baseline may correspond to (i) vehicle type, (ii) vehicle size, (iii) driving patterns of the user, such as distance driven by the user and driving style (those who avoid rush hour, those who elect use of freeways). The parameters may be selected to influence the actor that is to be influenced from the objective. For driving activity, the parameters selected for a driver may seek to influence his automobile purchase, the use of the automobile (whether the user car pools or commutes regularly), and the driving style of the user. In this respect, the totality of the objective (influence a person to have less vehicle emission) is considered when determining the baseline model.

In contrast, if the actor being influenced is the vehicle manufacturer, the objective may seek a more simple baseline that focuses on the properties of the vehicle. Still, the objective totality calculations will tell the manufacturer how to optimize the new properties to get maximum credit, such as minimizing fuel consumption is stop and go traffic with less than 40 mph top speed, where probably good aerodynamics matter less than low weight and strong electric generator brakes.

Step 220 provides that the selected activity or activities of the objective are monitored for a particular entity or scenario. For example, an embodiment such as described may be implemented in the context of a community or group of entities who elect to participate in the activity. Certain metrics from an entity performing the activity (or activities of the objective) may be recorded. In an embodiment in which the activity (or activities of the objective) corresponds to driving or driving behavioral parameters, the activity may correspond to the user's speed (average and/or at select instances), driving pattern, the fuel consumption of the entity's vehicle, and metrics that reflect condition or behavior of the user driving the vehicle. Various tools or metrics may be evaluated. For example, some metrics may be recorded through use of a computer on the vehicle and/or through Global Positioning System units. Other metrics may utilize an onboard computer of the vehicle to report information such as trip miles, air pressure, fuel efficiency of the vehicle (which can reveal driving pattern).

In step 230, the recorded values of the selected activity for a given user or participant may be calculated. More specifically, the metrics of a particular entity's activity (as performed) may be recorded and then compared to established baseline criteria or model using pre-determined formulas, algorithms or other means by which the comparison may be quantified.

As another example, for the activity of driving, the standard base line behavior of the ‘average vehicle’ may be established through an estimation (based on actual values) of fuel consumption at specific speed and acceleration. For a given entity for whom carbon footprint savings is being determined, the speed, acceleration and fuel consumption (i.e. the metrics) of that person's vehicle (when he or she is driving) may be determined and used for comparison to the baseline. As a more specific example, a person's car may be equipped with a tracking computer/component that tracks or records certain metrics, such as speed, acceleration and fuel consumption. The determination of the baseline model (for objective totality) determinations may be more involved and require better determination of real world data. In either case, the data and information used to determine baseline is fluid or dynamic, in that such information may change over time (e.g. year to year, week to week, or even day by day). For example, what constitutes carbon emission baseline for driving activity by a person may change from year to year, depending on factors such as the development of good driving habits by persons (to conserve fuel or reduce emissions) or even the price of fuel.

Moreover, geographic parameters may be considered in determining baseline formulations and or quantifications of carbon reduction. For example, embodiments may recognize that metropolitan areas offer better public transport, and enable modification to the baseline to account for comparison of any driver to that of a person who relies on public transport from time to time. The use of geographic parameters thus provides another example of using real world data and assumptions to determine baseline formulations or carbon emission reductions.

In step 240, Carbon Credits may be calculated from the values that are determined from comparing the metrics of an activity performed by a person to the established baseline metrics. In an embodiment, the values, as recorded by, for example, a tracking computer/component, may be transferred to another computer (e.g. a server on a network) and then compared at specific instances or durations to the behavior of the ‘average car’. If recent driving history in terms of metrics is recorded, the values may be transferred (e.g. downloaded and/or uploaded to a service) where carbon credits is determined. By calculating the carbon credits in such a manner, the results of the calculations are inherently more specific and more valid.

Once calculated, the Carbon Credits may be used as a form of value. A recipient of the Carbon Credits may, for example, exchange the Carbon Credits for a discount or other form of value with another party. Still further, market-based exchanges may be formed to enable the exchange of Carbon Credits for other consideration. Numerous other variations and alternatives are contemplated.

Still further, embodiments recognize that many fuel efficient cars, such as hybrids, have a computer managing their engines. Such a computer may be programmed to record and capture desired metrics.

In some embodiments, exchanges or other forms of markers (e.g. online markers) may be used to enable actors to acquire value for their conservation activities. In other embodiments, the carbon credits may be used to enable offsets-one actor can acquire carbon credits to offset a high carbon emission activity.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A system for quantifying carbon usage or reduction, the system comprising:
an activity monitor that is configured to detect a designated activity or behavior in order to generate data that reflects information about the user performing the designated activity; and
a calculator that is coupled to communicate with the activity monitor to receive the data, the calculator determining a quantity of carbon usage or reduction.

2. The system of claim 1, wherein the calculator is configured to determine a carbon credit amount by comparing the quantified carbon usage to a baseline formulation.

3. The system of claim 1, wherein the designated activity includes a single activity.

4. The system of claim 1, wherein the designated activity corresponds to a set of activities that are identified as being part of a conservation objective.

5. The system of claim 4, wherein the conservation objective corresponds to reducing carbon emissions related to personal transport of a user.

6. The system of claim 1, wherein the designated activity corresponds to tracking usage of electronic document delivery or communications in place of instances requiring physical courier transport or in-person communications.

7. A computer-implemented method for quantifying carbon usage or reduction, the method being implemented using one or more devices, including at least one or more processors, the method comprising:
identifying a set of activities that are part of a defined objective to reduce carbon emission;
determining a baseline for the set of activities;
monitoring an actor's performance of any one of the set of activities in order to determine information about how the user performed the set of activities; and
quantifying carbon conservation of the actor by comparing the information against parameters determined or identified from the baseline.

8. The method of claim 7, further comprising identifying a plurality of parameters that are characteristic to how one or more of the activities in the set are performed, wherein determining the baseline includes accounting for the parameters as part of the baseline, and wherein monitoring the actor's performance includes determining values of individual parameters associated with how the actor performs the one or more activities in the set.

9. The method of claim 8, wherein determining the baseline includes determining one or more values associated with the baseline for the identified parameters in the plurality of parameters, and wherein monitoring the actor's performance includes determining the one or more parameter values based on the actor's performance in performing one or more of the designated activities.

10. The method of claim 7, wherein determining a baseline is dependent at least in part on a geographic designation or location of the actor.

11. The method of claim 7, wherein determining a baseline is dependent at least in part on a classification of the actor.

12. The method of claim 7, wherein identifying a set of activities that are part of a defined objective to reduce carbon emission includes identifying a set of activities that are part of the objective to reduce carbon emission during personal transport of the actor.

13. The method of claim 12, wherein the set of activities include one or more activities selected from (i) a type of vehicle the actor drives, (ii) a time of day that the driver drives, (iii) a distance of the driver's use of the vehicle, (iv) a distance traveled by the actor in the vehicle, (v) a style of driving of the actor, (vi) an amount that the actor commutes.

14. The method of claim 7, further comprising enabling the actor to exchange a carbon credit corresponding to the quantified carbon conservation.
